(19) United States
(12) Patent Application Publication
(10) Pub. No.: US 2011/0019791 A1
(43) Pub. Date: Jan. 27, 2011

(54) SELECTION OF OPTIMAL VIEWS FOR COMPUTED TOMOGRAPHY RECONSTRUCTION

(75) Inventor: Klaus Mueller, New York, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: The Research Foundation of State University of New York, Albany, NY (US)

(21) Appl. No.: 12/842,274

(22) Filed: Jul. 23, 2010

Related U.S. Application Data
(60) Provisional application No. 61/228,246, filed on Jul. 24, 2009.

(51) Int. Cl. G01N 23/00

(52) U.S. Cl. 378/8

(57) ABSTRACT

Methods of making iterative low-dose computed tomography (CT) efficient and applicable to clinical practice employ selection of optimal views for CT reconstruction. By optimizing the views for CT reconstruction, the method of the present invention can generate reconstructions at a pre-specified low radiation dose and/or in near real-time. A feature-oriented framework for a task-driven, object-driven, and dose-minimizing selection of X-ray views is provided, which can utilize models of features to be mapped. The models can be derived from a patient population to minimize the dose per exam and/or from a specific patient to minimize the dose per procedure. The method of the present disclosure can be incorporated into a CT system, or can be embodied in a data storage medium as a program.

### CLAIM OF PRIORITY

This application claims the benefit of priority from U.S. provisional application No. 61/228,246 filed with the United States Patent and Trademark Office on Jul. 24, 2009.

### STATEMENT REGARDING FEDERALLY SPONSORED RESEARCH OR DEVELOPMENT

This invention was made with government support under grant No. CCF 0702699 awarded by the National Science Foundation and grant No. EB 004099-01 awarded by the National Institute of Health. The government has certain rights in this invention.

### FIELD OF THE INVENTION

The present invention relates to a method of selecting optimal views for computed tomography reconstruction, a computed tomography system configured to select optimal views for computed tomography reconstruction, and a data storage medium embodying a program that selects optimal views for computed tomography reconstruction.

### BACKGROUND OF THE INVENTION

Recent studies in the US show that from 1993 to 2006 the number of computed tomography (CT) imaging procedures has increased at an annual rate of over 10%, leading to a considerable increase in patient radiation dose. Although CT only amounts to about 15% of the total number of radiological imaging procedures, it contributes to over 50% of the medical radiation dose to the US population. This has rather serious health consequences. For example, one study suggests that 0.4% of all recent cancer deaths can be attributed to CT radiation dose incurred between 1991 to 1996.

It is due to this growing dose awareness that low dose CT imaging has been gaining considerable momentum recently. Essentially, the strategies available to lower CT patient dose are three-fold: (1) reduce the number of CT exams per procedure or health condition, (2) reduce the number of X-ray projections (views) taken per exam and (3) reduce the amount of X-ray energy (kV, mA) expended per X-ray projection. More specifically, while a conventional CT scan typically has a dose of around 30 mGy, a 25-view low-energy CT scan would reduce the dose by 95%, to around 1.5 mGy.

In prior art low dose CT imaging schemes, fairly regular schemes for viewpoint sampling are employed for CT reconstruction. For example, T. Wu et al., “Tomographic mammography using a limited number of low-dose cone-beam projection images,” Medical Physics, 30(3):365-380, 2003 presents a number of view selection patterns represented by their Fourier slice spacing in the frequency domain. All of the prior art view selection patterns described as regular and periodic function in the angular coordinate.

The frugal use of X-ray radiation, as demanded by low-dose CT, however, has its drawbacks. It starves the well-established fast and high-quality analytical reconstruction schemes from the massive X-ray projection data they require, reducing their effectiveness. The realities of low-dose CT are noisy and sparse X-ray projections, which subsequently lead to significant noise and streak artifacts in the reconstructions, obliterating the structures of interest. Mounting evidence exists that these adverse conditions are bound to usher in a new era in medical CT reconstruction, one in which iterative reconstruction algorithms will likely greatly gain in popularity. See for example, X. Pan, E. Sidky, and M. Vannier, “Why do commercial CT scanners still employ traditional, filtered back-projection for image reconstruction?” Inverse Problems, 25:123009, 2009.

Iterative schemes replace the closed-form mathematics of analytical CT reconstruction by numerical optimization. Then, via numerical optimization one can effectively exploit the fact that medical images offer a great deal of prior knowledge about the objects to be reconstructed, lending great prospects to offset the lack of abundant raw data in low-dose CT. Obviously, the most dose-efficient X-ray projection is the one that is not acquired at all. X-ray radiography is governed by guidelines that prescribe the most optimal X-ray view to best show a condition or feature of interest.

### SUMMARY OF THE INVENTION

In the present disclosure, methods of making iterative low-dose computed tomography (CT) efficient and applicable to clinical practice employ the selection of optimal views for CT reconstruction. By optimizing the views for CT reconstruction, one can reduce the number of views acquired per scan and as a consequence lower the X-ray exposure administered to the patient. Further, optimizing the views can also lead to reduced scan time and so generate reconstruction results in near real-time. This can be of importance in time-optimized imaging scenarios, such as industrial scans. A feature-oriented framework for a task-driven, object-driven, and dose-minimizing selection of X-ray views is provided, which can utilize models of features to be mapped. The models can be derived from a patient population and/or from a specific patient to minimize the dose per exam or procedure. The method of the present disclosure can be incorporated into a CT system, or can be embodied in a data storage medium as a program.

According to an aspect of the present invention, a method of operating a computed tomography apparatus includes: selecting a set of viewing angles based on a model representing geometry of an object to be scanned; generating projections of the object by scanning the object at the set of viewing angles; and generating a computed tomography image from the projections.

According to another aspect of the present invention, a computed tomography apparatus includes: an X-ray source having a movable X-ray emission point; detectors configured to detect X-ray; a mechanical drive system configured to move the X-ray source and the detectors according to information transmitted from a computing means. The computing means is configured to perform a sequence of operations including: selecting a set of viewing angles based on a model representing geometry of an object to be scanned; and generating projections of the object by scanning the object at the set of viewing angles; and generating a computed tomography image from the projections.

According to yet another aspect of the present invention, a machine readable non-transitory tangible medium embodying a program for operating a computed tomography apparatus is provided. The program includes steps for: selecting a set of viewing angles based on a model representing geometry of an object to be scanned; generating projections of the object by scanning the object at the set of viewing angles; and generating a computed tomography image from the projections.

### BRIEF DESCRIPTION OF THE DRAWINGS

FIG. 1A is an exemplary view selection generated by edge clustering in Hough Space.

FIG. 1B is the edge clustering in Hough Space leading to the exemplary view selection of FIG. 1A

The arrows indicate advantageous viewing angles, and the boxes indicate detectors. FIG. 1B schematically illustrates the distribution of the angular orientations and radial distances of these advantageous viewing angles in FIG. 1A as six clusters in Hough Space.

FIG. 2 is an illustration of an exemplary system in which three-dimensional viewing angles are enabled. A more generalized gantry with independent source and detector is also supported by this invention.

FIG. 3A is a reconstruction from the optimal views, which shows a phantom for the set of test objects consisting of various geometric base shapes: squares, circles, ellipsoids.

FIG. 3B is a reconstruction from 13 optimal views, which shows the matching of the phantoms in FIG. 3A with high accuracy. Remaining streak artifacts can be eliminated via regularization methods not part of this invention.

FIG. 4 is an example of the Hough transform on the edge image of the set of test objects of FIG. 3A.

FIG. 5 shows an exemplary apparatus according to an embodiment of the present invention.

### DETAILED DESCRIPTION OF THE INVENTION

As stated above, the present invention relates to a method of selecting optimal views for computed tomography reconstruction, a computed tomography system configured to select optimal views for computed tomography reconstruction, and a data storage medium embodying a program that selects optimal views for computed tomography reconstruction, which are now described in detail with accompanying figures. It is noted that like and corresponding elements mentioned herein and illustrated in the drawings are referred to by like reference numerals. It is also noted that proportions of various elements in the accompanying figures are not drawn to scale to enable clear illustration of elements having smaller dimensions relative to other elements having larger dimensions.

As used herein, a “viewing angle” or a “coverage” refers a set of contiguous two-dimensional angles or three-dimensional angles along which an X-ray beam is projected during scanning an object.

The great advances in CT technology, such as detectors, beams, gantries, and algorithms, have led to vastly improved acquisition speed, image resolution and image quality. As a consequence, we have witnessed tremendous increases in the use of CT technology, for both medical diagnostics and intra-operative imaging. This growth is likely to continue as more useful procedures involving CT are being developed. A large part of this projected increase will probably come from new CT-based screening programs for asymptomatic patients, including CT virtual colonoscopy, CT smoke-related lung screening, CT cardiac screening, CT whole-body screening, and also CT intra-operative surgery.

A serious obstacle to these new and desirable capabilities, however, is the radiation cost to the patient. Many applications are currently clinically infeasible because the radiation dose to the patient is too high. In addition, there is also a growing public awareness to radiation dose, as long-term studies on their cancer risks emerge. Therefore, low dose CT is an important overall aim to pursue.

With a new generation of more flexible CT scanners that are currently emerging, much more freedom in choosing specific source-detector trajectories is allowed. Utilizing such new CT scanners, the present disclosure enables information-optimized and dose-minimized views, thereby sparing organs from high effective dose of radiation. To determine such information-optimized and dose-minimized views, new X-ray specific view-analytical frameworks are provided. These frameworks can be utilized both for repeated intra-operative CT scans and for diagnostic exam-based CT scans.

In the present invention, viewing angles are selected to remedy the problem of angular undersampling that occurs when low dose CT reconstruction scheme is employed. Projections can be acquired at non-regular sampling intervals even with regular C-arm scanners. New and more flexible scanners offer additional freedom in selecting irregular views. Examples of such new scanners include the ArtisZeego C-arm scanner by Siemens™, multi-axis systems based on robotic technology that can be arbitrarily positioned within the C-arm constraint reported in D. Kolditz et al., “Volume-of-interest (VOI) imaging in C-arm flat-detector CT for high image quality at reduced dose,” Medical Physics, 37(7), pp. 2719-2730, 2010, and the even more flexible laboratory prototype as disclosed in U.S. Pat. No. 7,441,953 to S. Banks.

The central underlying constraint to the optimal X-ray view selection problem is that in the context of CT, reliable reconstruction of a sharp discontinuity (an edge) from the projection data alone can be achieved only if some X-ray in some of the projections is tangent to this curve of the sharp discontinuity. See E. Quinto, “Singularities of the X-ray transform and limited data tomography in R2 and R3,” SIAM J. Math. Anal., 24:1215-25, 1993. While an infinite set of projections is required in theory in order to provide a reliable reconstruction of an arbitrary shape via CT imaging, clinically acceptable reconstructions can be obtained with a practically realizable finite set of views. As such, the present invention provides a ranking of projections in terms of their prospects to improve the fidelity of the subsequent CT reconstruction. This ranking can then be utilized to select the N best views for CT reconstruction under a given maximum dose constraint.

The present invention provides a method of selecting the most promising N projections to include rays that are tangent to all relevant discontinuities in the scanned target medium. In one embodiment, the present invention employs a model for an object to be scanned. The model includes information on the most likely and salient positions and orientations of the edges in the object. The model may be generated from a population-based model, which is a model that is based on a statistical average of positions of discontinuities from scans on similar objects, e.g., objects having similar characteristics as the object to be scanned. For example, the model may be based on the geometry of known anatomical features of humans or animals. Such a model can be employed, for example, in a diagnostic scan, and in general, whenever prior scan data is not available. Alternately or in conjunction, the model may be generated or modified from a prior scan of the same object in an interventional scenario or for follow-up scans, i.e., whenever any prior scan data on the same object is available.

The edge points are locations of sharp changes in image intensity and can be determined via edge detection. Edge detection has been well studied in the past. The majority of the existing methods can be grouped into two categories, gradient methods and Laplacian methods. The gradient method detects the edges by looking for the maximum and minimum in the first derivative of the image. The Laplacian method searches for zero crossings in the second derivative of the image to find edges.

A Hough transform can be run on the edge points generated by the edge detector. See, for example, R. Duda et al., “Use of the Hough Transformation to Detect Lines and Curves in Pictures,” Comm. ACM, Vol. 15, pp. 11-15, 1972). The Hough transform is a feature extraction technique used in image analysis, computer vision, and digital image processing. Its purpose in this invention is to determine the most prominent edges of the object via a voting procedure. This voting procedure is carried out in a parameter space, from which edge candidates are obtained as local maxima in a so-called accumulator space that is explicitly constructed by the Hough transform algorithm. The voting procedure results in clusters of edge points, each parameterized by the corresponding edge's angular orientation and orthogonal radial distance from the image center.

While an embodiment of the present invention may be practiced employing a Hough transform, any other alternative to a Hough transform can also be employed to detect the most prominent edges. In other words, the Hough Transform is a convenient way to detect the prominent edges based on the geometry of a model, but is not exclusive means for practicing the present invention. As long as the prominent geometry can be detected by any means to find an optimal set of viewing angles, any other alternative method for detecting the optimal set of viewing angles can be employed.

Edge points that are part of more prominent edges accumulate in denser clusters in this Hough Space. Advantageous viewing angles for reconstructing the object are determined by ranking the Hough Space clusters in terms of their density. The set of N most advantageous viewing angles can then be determined based on the order of this cluster ranking. The number N can be a predetermined fixed number, or can be a variable number set at a minimal value that can provide a CT reconstruction at a predetermined minimum quality or at a better quality. This analysis yields the optimal locations and orientation of detectors (or detector patches) by which the object can be reconstructed reliably. These detectors are arbitrarily sized and are associated with a physical detector in a subsequent step of the algorithm that is part of this invention.

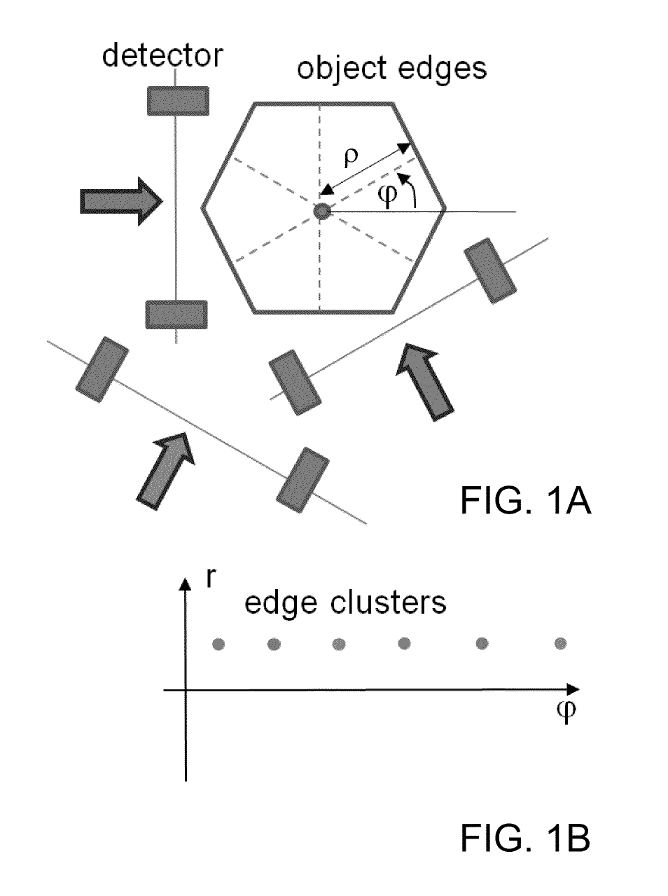

Referring to FIG. 1A, an exemplary object including six edges (depicted by the six solid lines of an equilateral hexagon) of certain angular orientations and radial distances are illustrated in a two dimensional schematics. The arrows indicate advantageous viewing angles, and the boxes indicate detectors (or detector patches). FIG. 1B schematically illustrates the distribution of the angular orientations and radial distances of these advantageous viewing angles in FIG. 1A as six clusters in Hough Space.

In general, the advantageous viewing angles can be angles in a two-dimensional plane, and can be characterized by a single variable φ, which has a value from 0 to 2π. Alternately, the advantageous viewing angles can be three-dimensional angles, which can be characterized by a set of two scalar parameters as in (θ, φ) in a three-dimensional spherical coordinate system in which θ refers to an azimuthal angle around a z-coordinate of an (x, y, z) Cartesian coordinate system and φ refers to a polar angle from the positive direction of the z-coordinate of the Cartesian coordinate system. If a (θ, φ) coordinate system is employed, the value of θ ranges from 0 to 2π, and the value of φ ranges from 0 to π. Any alternate coordinate system for specifying a three-dimensional angle can also be employed. The third dimension of this spherical coordinate system is the orthogonal radial distance of the patch normal vector.

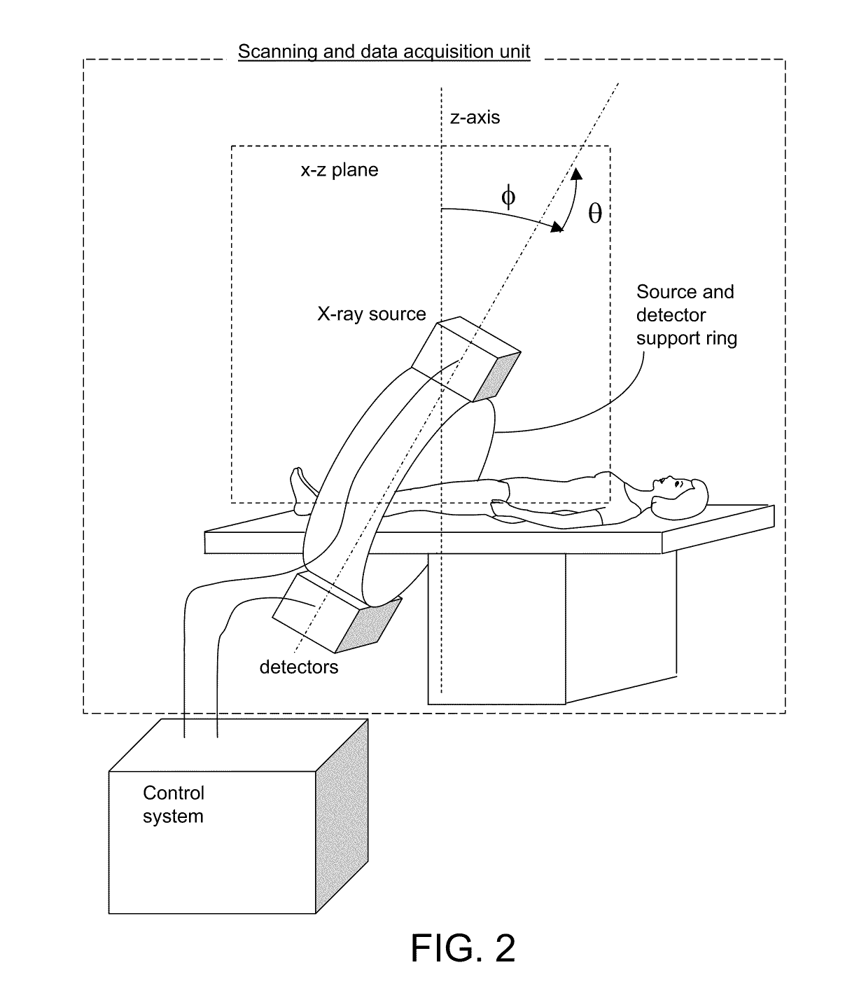

FIG. 2 illustrates an exemplary computed tomography system according to the present invention, in which three-dimensional viewing angles are enabled. The exemplary computed tomography system includes a scanning and data acquisition unit, a control system, and data transmission elements that can be signal cable or wireless communication devices. The X-ray source and the detectors can move together with fixed relative positions relative to one another by varying the angles φ and θ. Alternately or in conjunction, the detectors can move around the detector support ring. A more generalized gantry with independent source and detector is also supported by this invention. The vertical plane corresponds to the x-z plane of a Cartesian coordinate system, i.e., a plane at which the value of the angle θ is zero. Not necessarily but preferably, the detectors and the X-ray source can move along a set of viewing angles synchronously.

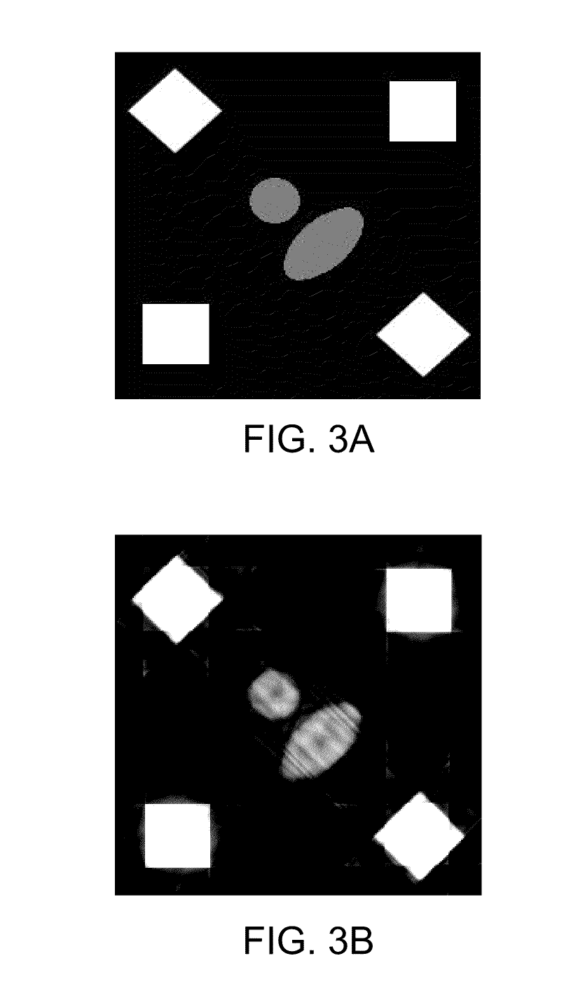

In the course of the research leading to the present invention, the concept of the present invention has been confirmed by test results that generated high quality images for a set of test objects. Referring to FIG. 3A, a phantom for the set of test objects is shown. FIG. 3B shows a reconstruction of the set of test objects generated from 13 views taken at calculated advantageous viewing angles. The reconstruction as shown in FIG. 3B matches the phantom shown in FIG. 3A with high accuracy.

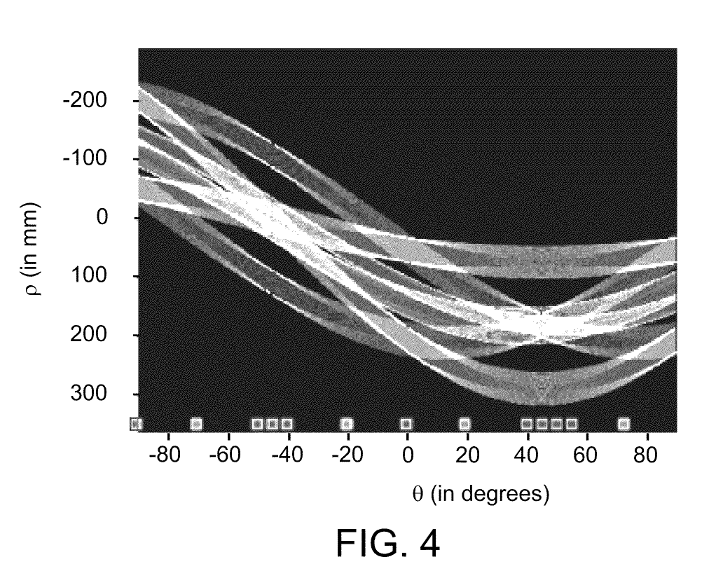

Referring to FIG. 4, an example of the Hough transform on the edge image of the set of test objects of FIG. 3A is shown. The horizontal axis represents a two-dimensional angle θ in degrees, and the vertical axis represents the radial distance ρ of the edge from the image center. This radial distance is the length of the vector normal to the edge represented by the cluster, passing through the image center and intersecting with the edge. The angle θ then determines the orientation of the corresponding detector and the radial distance determines the patch region. A physical detector positioned at that orientation could then be collimated to this patch region.

In one embodiment, the identified oriented detectors can be grouped into a set of full projections using an approximate set covering algorithm to yield the minimum set of non-collimated views. For example, the approximate set covering algorithm can be employed as disclosed in V. Vazirani, Approximation Algorithms, Springer-Verlag, 2001. In this case, an optimal path connecting the minimum set of non-collimated views into a smooth gantry trajectory can be computed by employing methods known in the art, which can be, for example, the method disclosed in J. C. Latombe, Robot Motion Planning, Kluwer Academic Publishers, 1991.

Recent work on sinogram-based view interpolation demonstrates that there exists a fair amount of structure reproducibility from neighboring views. A sinogram is a visual representation of the raw data obtained in a computed axial tomography (CT) scan. See, for example, D. Brenner et al., “Estimated radiation risks potentially associated with full-body CT screening,” Radiology, 232:735-738, 2004. Thus, some deviation from the model and registration with the scanner is tolerable. Consequently, the model to be reconstructed does not need to be completely known or well-registered via computer vision or electromagnetic probes with the scanner in practicing the present invention.

In one embodiment, the method of the present invention can be used to aid approaches that utilize a population-based model to reconstruct new previously unseen objects. These approaches typically create a high-dimensional correspondence map for each instance of the population, which can be generated by an Active Shape Model warp or an equivalent method. See, for example, T. Cootes et al., “Active shape models—their training and application,” Computer Vision and Image Understanding (61):38-59, 1995. The high-dimensional space is first reduced by some low-dimensional space embedding, such as principal component analysis (PCA) or locally linear embedding. In principal component analysis (PCA), a number of possibly correlated variables are transformed into a smaller number of uncorrelated variables called principal components. In locally linear embedding, an unsupervised learning algorithm that computes low-dimensional, neighborhood-preserving embeddings of high-dimensional inputs.

Employing such methods for new previously unseen objects, likely new objects can then be created by interpolating in a “space of objects.” CT reconstruction algorithms based on this concept seek to match the projections to these likely objects via some optimization procedures known in the art, such as those disclosed in S. Kadoury et al., “Personalized X-Ray 3-D Reconstruction of the Scoliotic Spine From Hybrid Statistical and Image-Based Models,” IEEE Trans Medical Imaging, 28(9):1422-1435, 2009 and R. Li et al., “Real-time volumetric image reconstruction and 3D tumor localization based on a single x-ray projection image for lung cancer radiotherapy,” Medical Physics, 37(6):2822-2826, 2010.

In implementing the methods described above, a critical part is to determine which projections (i.e., views) are most useful to this optimization so that the most important projections can be selected to facilitate reconstruction of new previously unseen objects, minimizing dose. The population data can be utilized to determine, via deformation vector field analysis using the well-known Demons algorithm, a model deviation vector field. For the Demons algorithm, see, for example, J. Thirion, “Image matching as a diffusion process: An analogy with Maxwell's demons,” Med. Image Anal. 23, 243-260, 1998. Clustering these deformation vectors yields a set of directions along which the most prominent variations occur in the population. Projections from directions perpendicular to these vectors can then be used to determine where in the space of likely objects the currently imaged object falls. This leads to favorable convergence behavior of the optimization procedure matching the projections to the space of likely objects and in turn leads to faithful reconstructions.

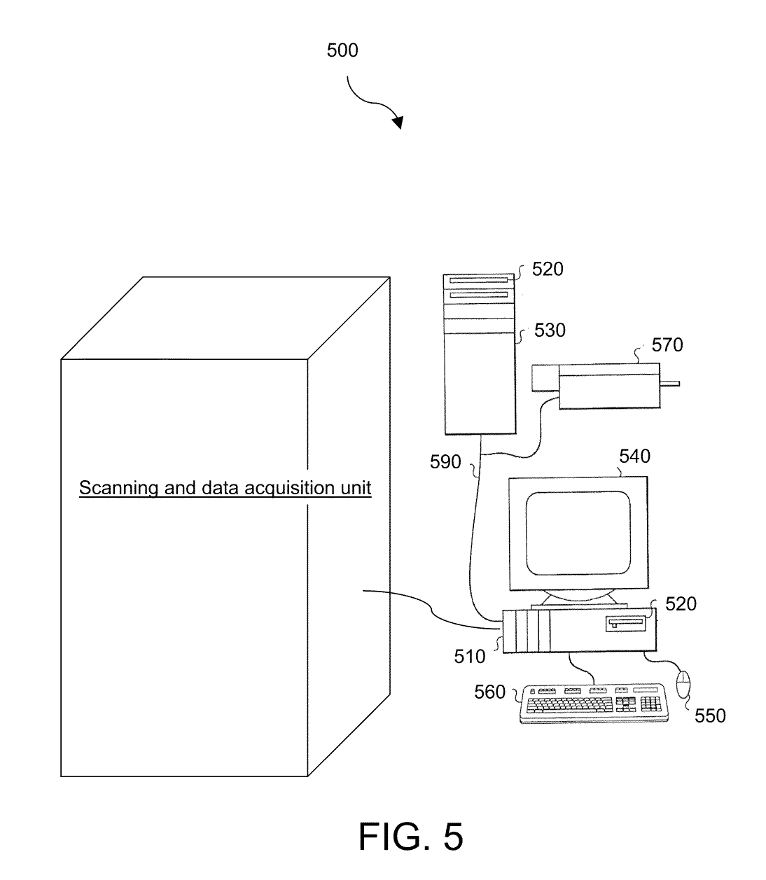

Referring to FIG. 5, an exemplary computed tomography system 500 according to the present invention is shown. The exemplary computed tomography system 500 includes a computing device that is configured to perform program instructions. The computing device can include a memory and a processor device in communication with the memory. The program instructions can configure the computing device to perform the steps of embodiments of the present invention described above. The exemplary computed tomography system 500 can be a computer-based system in which the methods of the embodiments of the invention can be carried out by an automated program of machine-executable instructions to generate information from an object, which can be a human, an animal, or an inanimate object with internal features therein.

The computer-based system includes a processing unit 510, which can be a computing device and houses a processor device, a memory and other systems components (not shown expressly in the drawing) that implement a general purpose or special purpose processing system, or can be a computer that can execute a computer program product. The computer program product can comprise data storage media, such as a compact disc, which can be read by the processing unit 510 through a disc drive 520. Alternately or in addition, the data storage media can be read by any means known to the skilled artisan for providing the computer program product to the general purpose processing system to enable an execution thereby. The exemplary system 500 includes a scanning and data acquisition unit, which can be the same as the scanning and data acquisition unit described in FIG. 2. The memory and the processor device are provided within the processing unit 510. The scanning and data acquisition unit can be operated by employing the processor device and the memory by providing instructions to the processor device employing the program to enable the features of the present invention.

A data storage device are also provided herein that is programmable and readable by a machine and non-transitorily and tangibly embodying or storing a program of machine-executable instructions that are executable by the machine to perform the methods described. For example, the automated program can be embodied, i.e., stored, in a machine-readable data storage devices such as a hard disk, a CD ROM, a DVD ROM, a portable storage device having an interface such as a USB interface, a magnetic disk, or any other storage medium suitable for storing digital data. The program of machine-executable instructions can be employed to sequence a nucleic acid employing a system of the present invention.

The computer program product can comprise all the respective features enabling the implementation of the inventive method described herein, and which is able to carry out the method when loaded in a computer system. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product can be stored on hard disk drives within the processing unit 510, as mentioned, or can be located on a remote system such as a server 530, coupled to the processing unit 510, via a network interface such as an Ethernet interface or wireless connection. A monitor 540, a mouse 550 and a keyboard 560 are coupled to the processing unit 510, to provide user interaction. A printer 570 can be provided for document input and output. The printer 570 is shown coupled to the processing unit 510 via a network connection, but can be coupled directly to the processing unit 510. All peripherals might be network coupled, or direct coupled without affecting the ability of the processing unit 510 to perform the method of the invention.

The present invention can be employed in many fields, including, but not limited to, interventional orthopedics and security scanning systems. The theoretical concepts derived from the present invention are quite general, and can provide improvement in many scientific disciplines.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

What is claimed is:

1. A method of operating a computed tomography apparatus comprising:
selecting a set of viewing angles based on a model representing geometry of an object to be scanned;
generating projections of said object by scanning said object at said set of viewing angles; and
generating a computed tomography image from said projections.

2. The method of claim 1, further comprising selecting a set of locations for detectors that correspond to each viewing angle in said set of viewing angles.

3. The method of claim 2, further comprising moving an X-ray source while generating said projections of said object, wherein said detectors and said X-ray source move along said set of viewing angles synchronously.

4. The method of claim 1, further comprising setting a predetermined number of total viewing angles for said set of viewing angles prior to selecting said set of viewing angles.

5. The method of claim 1, further comprising determining a total number of viewing angles in said set of viewing angles based on said geometry of said object in said model.

6. The method of claim 1, wherein said model is a population-based model based on statistical average of positions of discontinuities from scans of objects similar to said object.

7. The method of claim 1, wherein said model is a model generated by, or modified by, a prior scan of said object.

8. The method of claim 1, wherein said set of viewing angles include viewing angles that are not regularly spaced from adjacent viewing angles.

9. The method of claim 1, wherein said set of viewing angles include two-dimensional angles confined within a two-dimensional plane.

10. The method of claim 1, wherein said set of viewing angles include three-dimensional angles.

11. The method of claim 1, further comprising reconstructing at least one new previously unseen object while generating said computed tomography image.

12. The method of claim 10, wherein said set of viewing angles is selected to facilitate reconstruction of new previously unseen objects.

13. The method of claim 1, further comprising performing a Hough transformation on edge points of said model to generate a cluster of angular orientations and radial distances of prominent edges in said model.

14. A computed tomography apparatus comprising:
an X-ray source having a movable X-ray emission point;
detectors configured to detect X-ray;
a mechanical drive system configured to move said X-ray source and said detectors according to information transmitted from a computing means, wherein said computing means is configured to perform a sequence of operations including:
selecting a set of viewing angles based on a model representing geometry of an object to be scanned;
generating projections of said object by scanning said object at said set of viewing angles; and
generating a computed tomography image from said projections.

15. The computed tomography apparatus of claim 14, wherein said computing means is configured to enable selection of a set of locations for detectors that correspond to each viewing angle in said set of viewing angles.

16. The computed tomography apparatus of claim 15, wherein said computing means is configured to enable moving an X-ray source while generating said projections of said object, wherein said detectors and said X-ray source move along said set of viewing angles synchronously.

17. The computed tomography apparatus of claim 14, wherein said computing means is configured to enable setting of a predetermined number of total viewing angles for said set of viewing angles prior to selecting said set of viewing angles.

18. The computed tomography apparatus of claim 14, wherein said computing means is configured to enable determination of a total number of viewing angles in said set of viewing angles based on said geometry of said object in said model.

19. The computed tomography apparatus of claim 14, wherein said computing means is configured to enable use of a population-based model based on statistical average of positions of discontinuities from scans of objects similar to said object for said model.

20. The computed tomography apparatus of claim 14, wherein said computing means is configured to enable use of a model generated by, or modified by, a prior scan of said object for said model.

21. The computed tomography apparatus of claim 14, wherein said computing means is configured to enable said set of viewing angles to include viewing angles that are not regularly spaced from adjacent viewing angles.

22. The computed tomography apparatus of claim 14, wherein said computing means is configured to enable said set of viewing angles to include two-dimensional angles confined within a two-dimensional plane.

23. The computed tomography apparatus of claim 14, wherein said computing means is configured to enable said set of viewing angles to include three-dimensional angles.

24. The computed tomography apparatus of claim 14, wherein said computing means is configured to enable reconstruction of at least one new previously unseen object while generating said computed tomography image.

25. The computed tomography apparatus of claim 24, wherein said computing means is configured to enable selection of said set of viewing angles to facilitate reconstruction of new previously unseen objects.

26. The computed tomography apparatus of claim 14, wherein said computing means is configured to enable operation of a Hough transformation on edge points of said model to generate a cluster of angular orientations and radial distances of prominent edges in said model.

27. A machine readable non-transitory tangible medium embodying a program for operating a computed tomography apparatus, said program comprising steps for:
selecting a set of viewing angles based on a model representing geometry of an object to be scanned;
generating projections of said object by scanning said object at said set of viewing angles; and
generating a computed tomography image from said projections.

28. The machine readable non-transitory tangible medium of claim 27, wherein said program further comprises steps for selecting a set of locations for detectors that correspond to each viewing angle in said set of viewing angles.

29. The machine readable non-transitory tangible medium of claim 28, wherein said program further comprises steps for moving an X-ray source while generating said projections of said object, wherein said detectors and said X-ray source move along said set of viewing angles synchronously.

30. The machine readable non-transitory tangible medium of claim 27, wherein said program further comprises steps for setting a predetermined number of total viewing angles for said set of viewing angles prior to selecting said set of viewing angles.

31. The machine readable non-transitory tangible medium of claim 27, wherein said program further comprises steps for determining a total number of viewing angles in said set of viewing angles based on said geometry of said object in said model.

32. The machine readable non-transitory tangible medium of claim 27, wherein said program employs a population-based model based on statistical average of positions of discontinuities from scans of objects similar to said object for said model.

33. The machine readable non-transitory tangible medium of claim 27, wherein said program employs a model generated by, or modified by, a prior scan of said object for said model.

34. The machine readable non-transitory tangible medium of claim 27, wherein said set of viewing angles include viewing angles that are not regularly spaced from adjacent viewing angles.

35. The machine readable non-transitory tangible medium of claim 27, wherein said set of viewing angles include two-dimensional angles confined within a two-dimensional plane.

36. The machine readable non-transitory tangible medium of claim 27, wherein said set of viewing angles include three-dimensional angles.

37. The machine readable non-transitory tangible medium of claim 27, wherein said program further comprises steps for reconstructing at least one new previously unseen object while generating said computed tomography image.

38. The machine readable non-transitory tangible medium of claim 27, wherein said program selects said set of viewing angles to facilitate reconstruction of new previously unseen objects.

39. The machine readable non-transitory tangible medium of claim 27, wherein said program further comprises steps for performing a Hough transformation on edge points of said model to generate a cluster of angular orientations and radial distances of prominent edges in said model.
